(19) United States
(12) Patent Application Publication
(10) Pub. No.: US 2008/0070207 A1
(43) Pub. Date: Mar. 20, 2008

(54) System and Method for Testing Memory

(76) Inventor: LAWRENCE H AVIDAN, SAUSALITO, CA (US)

Correspondence Address: PROCENTRIS, INC., 1001 BRIDEWAY, # 995, SAUSALITO, CA, 94965, US

(21) Appl. No.: 11/469,906

(22) Filed: Sep. 5, 2006

(51) Int. Cl. G09B 19/00

(52) U.S. Cl. 434/236

(57) ABSTRACT

Different memory testing programs, systems, and methods for conducting memory tests, and for storing and displaying test data and trends residing on a client's machine are disclosed. The tests generally are based on generating a random sequence of signals, displaying the sequence to an examinee, the examinee memorizing the sequence, and inputting the sequence into the testing program. The signals could have visual, auditory, and/or positional components. The signals could also be alphanumeric strings.

The testing program measures test outcome variables, computes a composite memory score based on the test outcome variables, records and displays the stored test data. The testing device may also include a communication interface for periodically transferring the stored test data to a database residing on a remote server displaying the test data of the examinee on a website through an internet connection.

This application incorporates by reference the contents of application No.11469903 dated 5 Sep. 2006 titled “An Apparatus and Method for Testing Memory” (Lawrence Avidan)

### BACKGROUND OF THE INVENTION

1. Field of the Invention

The invention relates to the field of computer-implemented cognitive capacity testing systems, more particularly the field of memory testing systems that are network-enabled and that enable remote monitoring of test results.

2. Description of Related Art

Dementia is a syndrome of progressive decline in multiple domains of the cognitive function, eventually leading to an inability to maintain normal social and/or occupational performance. Dementia is considered to be a major public health challenge since the median age of the industrialized world's population is increasing steadily. It is estimated that within the next 20 years, one in every five persons in the United States will be over the age of 65.

At present, Alzheimer's disease (AD) is the most common form of dementia, afflicting approximately 4 million Americans. The cost to the U.S. society is estimated to be at least $100 billion every year, making AD the third most costly disorder of aging. Advancing age is the primary risk factor for AD. Among people aged 65, 2-3% show signs of the disease, while 25-50% of people aged 85 have symptoms of Alzheimer's. Every five years after the age of 65, the probability of having the disease doubles. The proportion of people with Alzheimer's begins to decrease after age 85 because of the increased mortality due to the disease, and relatively few people over the age of 100 have the disease.

The most striking early symptom of AD is short-term memory loss (amnesia), which usually manifests as minor forgetfulness that becomes steadily more pronounced as the illness progresses, with relative preservation of older memories. As the disorder progresses, cognitive (intellectual) impairment extends to the domains of language (aphasia), skilled movements (apraxia), recognition (agnosia), and decision-making.

Early identification is critical in progressive conditions such as dementia, because early treatment may be more effective than later treatment in preserving the cognitive function. However, in early stages, there is no major problem in daily life, and it is difficult to detect dementia.

A variety of tests has been used for diagnosing dementia in general and AD in particular. Examples of such tests include the abbreviated mental test score (AMTS) and the mini mental state examination (MMSE). These tests, however, are influenced by the patient's educational level.

Usually the tests are administered manually and consist of face-to-face testing in a testing site such as a physician's office. Aside from the traditional face-to-face testing, there are computer-implemented techniques for cognitive testing, for example, Neurobehavioral Evaluation System (NES2). In addition, the administration of the test in a doctor's office or clinic setting can be stressful to the examinee, thereby reducing their performance, adding in artifact to the examinee's performance.

A major problem with the currently practiced manual and computer-implemented tests is the low frequency of the tests. The testing frequency is governed by the convenience or ability of the person to travel to the testing site. For these reasons, cognitive testing frequency has been usually limited to one test before start of treatment and another test several weeks or months later.

Repeated testing on a regular basis is needed to monitor trends in memory. For example, it may be desired to evaluate the impact of alternative drug-based therapies, behavioral therapies, or any other therapies for dementia or AD. Regular monitoring of memory could reveal subtle changes, which may be missed out, in infrequent testing. It may also enable detection of undesirable side effects and allow timely intervention by a therapist.

U.S. Pat. No. 4,359,220 discloses a microcomputer-controlled game utilizing a microprocessor for controlling the play of one or more games in which a participant may play against the machine or against another participant. The game includes a portable housing having a top surface subdivided into a plurality of playing areas, each of which playing areas has two manually operable push buttons, and having a microprocessor within the housing. The microprocessor is located in the housing to control the illumination of the push buttons by light sources located below the top surface of the housing and to control the emission of distinct tones by a loudspeaker during the play of the games. However, this patent teaches only a game and does not teach how to measure memory.

U.S. Pat. No. 4,755,140 discloses an electronic personnel test device wherein a hand calculator provides an indicator of a subject's reaction time. An array of push-button keys has programmable varied numerals, which do not correspond to an orderly presentation. A display on the device instructs that a particular sequence of numbers be touch-indicated by the subject within a certain period of time. The touched sequence and time elapsed provides an indication of the subject's reaction time which could be influenced by fatigue, ill health and drug, including alcohol, use so that the subject's effectiveness for a particular duty can be evaluated. The device disclosed in this patent measures the reaction time of an examinee, but it does not teach how to measure memory and/or cognition capacity.

U.S. Pat. No. 4,770,636 discloses a cognometer, which is programmed for repeated, rapid, automated assessment and monitoring of memory and concentration. The memory monitor randomly generates data and displays the same in a common format, tests the user's comprehension of such data, tests the immediate recall of such data, and tests the delayed recall of such data. The concentration monitor randomly generates a long multi-digit number and displays the same, tests the user's comprehension of such number, and tests the concentration of the user by requiring the user to enter such number while the number is displayed, but without any position cue. However, this patent does not teach how to store test outcome variables and test scores, how the test results could be transmitted to a remote server, and how the results could be accessed in real-time by a medical practitioner or any authorized person.

U.S. Pat. No. 6,565,359 discloses a computer-implemented method and apparatus for remote cognitive and/or perceptual testing using a computer network having a remote computer geographically separate from an administering computer. The remote cognitive and/or perceptual testing includes administering a set of cognitive and/or perceptual tests, obtaining a performance response of the person to the tests and uploading the testing information via the computer network. The tests may be administered a number of times to evaluate one or more cognitive skills and/or perceptual abilities. Parallel to the testing, a therapy may be administered. The method may also include monitoring the performance of the person on the tests. The computer-implemented method may additionally include administering a set of initial tests before therapy inception to assess a person's intrinsic cognitive skills and/or perceptual abilities. The results of the initial testing and testing during therapy may be entered into a database. The database may be built from the performance response of multiple people and may be useful in predicting efficacy of a proposed therapy. However, this patent does not teach any specific memory measuring device or method nor does it teach how to transmit test results from a portable device to a server.

U.S. Pat. No. 6,654,695 discloses a dementia test system and the like for testing a dementia degree of a testee, and provides a dementia test system which is effective for preventing and finding, at early stage, an initial sign (initial dementia) of senile dementia. A dementia test apparatus comprising an answer obtaining section 131 for obtaining an answer of a testee to both a dementia degree test chart which requires a plurality kinds of judgment at the same time and obtains an answer in such a form that correction of judgement is objectively judged, and a dementia factor degree test chart comprising a combination of a plurality of question concerning sensibility and a plurality of answers alternatively selected from questions prepared for each of the former questions, and a dementia degree test section 132 for testing a dementia degree indicative of a current degree of dementia of the testee based on an answer obtained by the answer obtaining section, and for estimating transition of future dementia degree of the testee. However, this patent does not teach how the test results could be transmitted to a remote server, and how the results could be accessed in real-time by a medical practitioner or any authorized person.

U.S. Pat. No. 7,070,563 discloses memory tests using item-specific weighted memory measurements and uses thereof wherein a method of increasing the usefulness, sensitivity and specificity of tests that measure memory and facets of memory, including learning retention, recall and/or recognition. Specifically, the sensitivity and specificity of such tests are enhanced by selectively weighting the value of specific items recalled by the test subject, either by weighting such items within any specific testing trial or across numerous testing trials. Also disclosed are various methods of reducing ceiling effects in memory tests. The invention also provides improved tests which employ item-specific weighting for the diagnosis of Alzheimer's Disease and other dementia characterized by memory impairment, as well as a method of screening for and evaluating the efficacy of potential therapeutics directed to the treatment of such dementia. However, this patent does not teach how to store test outcome variables and test scores, how the test results could be transmitted to a remote server, and how the results could be accessed in real-time by a medical practitioner or any authorized person.

US Publication No. 2003/0009088 discloses a monitoring system for patients with at least one measuring device for medical and diagnostic values of the patient such as blood pressure, pulse, body temperature, blood sugar and the like, which measuring device is carried and operated by the patient. The invention proposes that the measuring device feature at least one transmitter for the wireless transmission of the recorded values to at least one local receiver. In this arrangement, it is particularly advantageous if the receiver is integrated into a mobile phone, which sends the recorded values to a central data processing device via a mobile telephone network. However, the publication does not teach about any memory-measuring device.

US Publication No. 2005/0053904 discloses a system and method for on-site cognitive efficacy assessment for determining diminishment in brain function in relation to at least one of specific adverse factors and specific tasks. The system involves establishing threshold levels for at least one brain function that is either affected by specific adverse factors or is used to perform specific tasks, or both. A test-taker is given a battery of tests from a portable testing unit, where the tests have been tailored to measure specific cognitive functions that can be affected by adverse factors, cognitive functions that are required to perform specific tasks, or both. Scores from the tests are compared to the threshold levels required to perform a task, and a determination is made concerning the capability of the individual to handle the task(s) in question. The portable testing unit may be connected to equipment whose use is denied for test results that fall below a normative level for the activity. However, the publication does not teach about a memory measurement device.

US Publication No. 2006/0074340 discloses a cognitive capacity measurement device and cognitive capacity measurement method to measure the cognitive capacity to reconstruct from incomplete data original data explainable by correspondence to brain function, to apply these results to conduct research on brain function and in the future to select and determine the suitability of training appropriate to each individual, and to contribute to early detection, etc. of diseases related to cognitive function such as Alzheimer type dementia, is made such that: a degraded image, which is an image for which specified processing has been conducted on an original image having a significant photographic object and the data for recognizing the aforementioned photographic object has been degraded, is displayed to a subject; the fact that the aforementioned photographic object has been recognized is received from the subject; the recognition time, which is the time required for the subject to recognize the aforementioned photographic object, is calculated based on these received results; and the cognitive capacity score, which is an index that digitizes the cognitive capacity of the subject by specified computations, is calculated from this recognition time and the challenge level data, which is data related to the challenge level of the aforementioned degraded image in conjunction with the recognition of the photographic object. However, this publication does not teach how to store test outcome variables and test scores, how the test results could be transmitted to a remote server, and how the results could be accessed in real-time by a medical practitioner or any authorized person.

Cognitive testing should provide user-friendly self-testing at home as well as monitoring of patients by medical practitioners and family members, as frequently as desired. It should also be possible to evaluate an individual's memory by his or her own previous performance, rather than only by the less sensitive comparison with the performance of others.

It is also desirable if the testing can be a fun exercise for the examinee, thus providing an incentive to the examinee to perform the tests regularly. It is also desirable if the tests are intellectually stimulating, because it has been reported that intellectual stimulation (e.g., playing chess or doing the crossword) can reduce the risk of dementia.

It is preferable if test results could be automatically transmitted from the testing application residing on a personal computer or mobile device to a remote server using an internet connection. This will enable a remote medical practitioner or any other authorized person to monitor the cognitive performance of an examinee in real time.

### SUMMARY OF THE INVENTION

The disclosed invention has been conceived and developed to overcome the limitations of previous cognition capacity testing devices and systems, particularly for patients suffering from dementia in general or from specific types of dementia, for example, Alzheimer's disease or Parkinson's disease.

One of the objects of the present invention was to develop a testing program, which is easy to use, so that it could be used by patients to test their memory on their own in a home setting. It was also an object of the invention to develop a program which can not only be used for testing memory, but which should be fun to use and also provide intellectual stimulation. It has been reported that participation in intellectually stimulating activities like chess and crossword puzzles before the onset or in the initial stages of dementia can arrest the progression of the disease.

Another object of the invention was to develop methods for computing composite memory scores, which would be able to detect early stages of the disease with high specificity and sensitivity, because therapy is more effective in early stages of the disease.

It was also an object of the invention to enable performance of repeated and regular testing and to record the test outcome variables and composite memory scores in a convenient manner in a memory of a personal computer (for example, a desktop computer, a laptop computer, etc.) or a mobile device (for example, a mobile phone, a PDA, etc.). The historical scores based on regular testing over a period of time for each examinee could be used to assess the progression of disease and also to provide objective feedback to therapists to evaluate the efficacy of alternative therapies.

It was also an object to be able to transmit the test outcome variables and composite memory scores of each examinee to a database on a remote server so that that medical practitioner, family members, and other authorized persons could monitor the performance of the examinees remotely from internet capable devices connectable to the remote server.

The disclosure describes different embodiments of a computer-readable medium residing on a client device and storing a memory testing software to conduct memory measurement tests. The client device in which the computer-readable medium containing the memory testing software resides may be a personal computer (for example, a desktop computer, a laptop computer, etc.) or a mobile device (for example, a mobile phone, a PDA, etc.). In an embodiment of the invention, an examinee or a medical practitioner, under whose direction the examinee is taking the memory test, selects a test variant and a test matrix. The memory testing software generates a random sequence of signals, displays the sequence to an examinee, the examinee memorizes the sequence and inputs the sequence into the user interface of the client device. The memory testing software measures test outcome variables based on timings and action of an examinee, and computes a composite memory score based on at least one of test matrix, test outcome variables, and normalization factors for learning effect, gender, and age of the examinee. The memory testing software records the test outcome variables and composite score data in a memory medium of the client device, and displays the stored test data.

Another embodiment of the memory testing software also includes a connection to a remote server for automatically transferring the stored test data (for example, test outcome variables, composite memory scores, etc.) from the memory medium of the client device to a database residing on the remote server. Authorized users ( for example, medical practitioners, family, etc. ) may access the stored test data through a web browser residing on an internet capable device (for example, a personal computer with an internet connection, a laptop with an internet connection, etc. ).

Another embodiment of the memory testing software generates and displays a random sequence of signals, which could be a combination of visual, auditory, and/or positional components. The visual component may include a color subcomponent, a pattern subcomponent, and/or a light intensity subcomponent.

An embodiment of the memory testing software may include a sequence generator module that contains instructions for generating a random sequence of signals. The memory testing software may also measure test outcome variables resulting from an examinee memorizing and inputting the sequence of signals into the client device. The memory testing software may also have a score computing module for computing composite score data based on at least one of test matrix, test outcome variables, and normalization factors for learning effect, gender, and age of the examinee. Composite score data may comprise of for example, memory scores, memory time series, memory trend charts, etc.

The examinee is supposed to memorize the sequence and press corresponding keys on the keyboard of the personal computer or the keypad of the mobile device in the same order. A variety of test outcome variables can be measured, for example, total string length, length of a signal tone, duration before starting input, average duration between inputs, maximum duration between any two inputs, duration between signal tones, etc.

Another embodiment of the memory testing software generates and displays a random alphanumeric string to the examinee, the examinee recalls the alphanumeric string and inputs the alphanumeric string into the testing program using a keyboard of the personal computer or the keypad of the mobile device. In this embodiment, a variety of test outcome variables can be measured, for example, total string length, duration of display of the alphanumeric string, duration before starting input, average duration between inputs, maximum duration between any two inputs, etc.

In another embodiment of the memory testing software, the random sequence of signals may be a sequence of voice objects. In this embodiment, the memory testing software may also include a speech synthesizer module for generating voice objects, and a speech recognition module for deciphering the spoken voice objects.

In another embodiment of the memory testing software, there are disclosed control menu settings to enable an examinee to select a test variant (for example, color variant, pattern variant, alphanumeric variant, voice variant, etc.), a test matrix (a battery of tests) and/or a test level (for example, easy, medium, difficult, etc.). In another embodiment of the testing program, the testing program also has a control module which automatically changes the test matrix based on composite score data and composite score trends of the examinee. Alternatively, in other embodiments, the test matrix may be changed manually.

In another embodiment of the invention, a memory measurement system is disclosed. The system comprises a memory testing software residing on a client device ( for example, a personal computer, a mobile device, etc. ), the memory testing software communicating with a database on a remote server, and an internet capable computer for accessing the database and for displaying the test data of the examinee through an internet connection. The score computing module may reside either on the memory testing software on the client device or on the remote server.

The disclosure also describes a method for conducting memory measurement tests comprising the steps of selecting a test variant and a test matrix, measuring test outcome variables, computing composite memory score data based on based on at least one of test matrix, test outcome variables, and normalization factors for learning effect, gender, and age of the examinee.

In another embodiment of the invention, the method also includes the steps of automatically transmitting, via a communication medium, the test data for each examinee from the memory testing software on the client device to a database residing on a remote server and displaying the test data to medical practitioners, family members, other authorized persons, etc through an internet capable computer.

### BRIEF DESCRIPTION OF PREFERRED EMBODIMENTS

Preferred embodiments are illustrated by way of example, and not by way of limitation, in the accompanying drawings and in which like reference numerals refer to similar elements and in which:

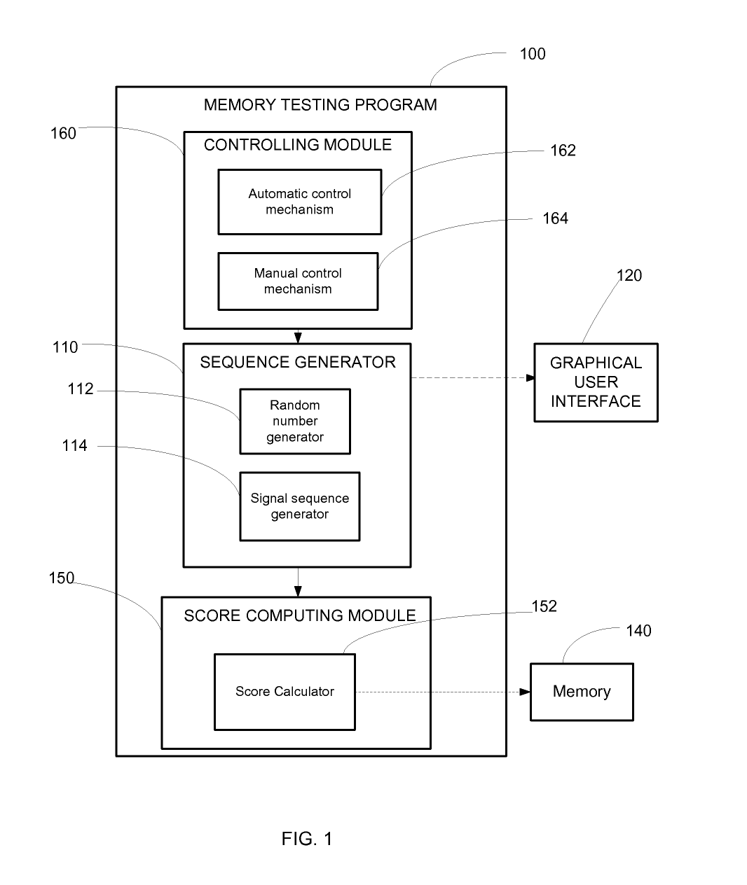

FIG. 1 shows an overview of an embodiment of the invention as disclosed herein.

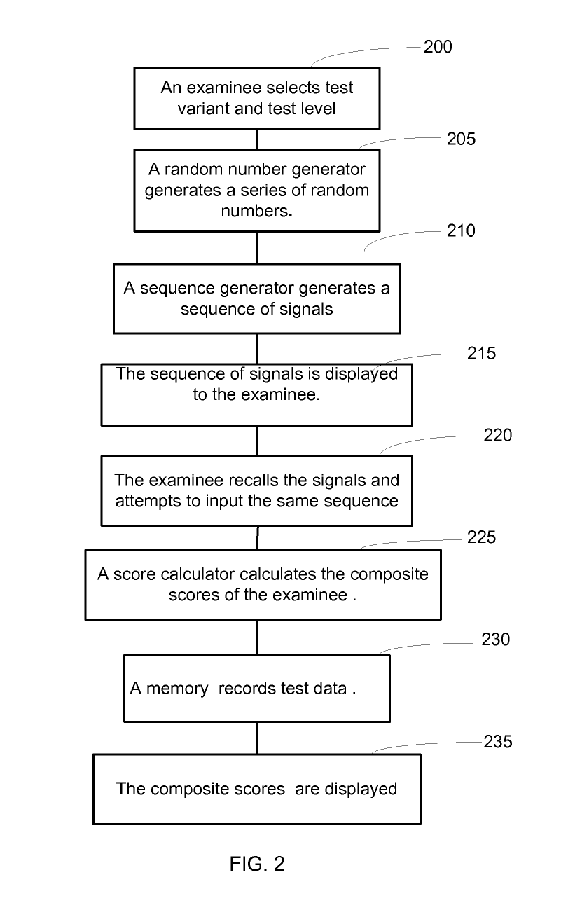

FIG. 2 shows a flow diagram illustrating the process flow for working of a memory testing program residing on a client device.

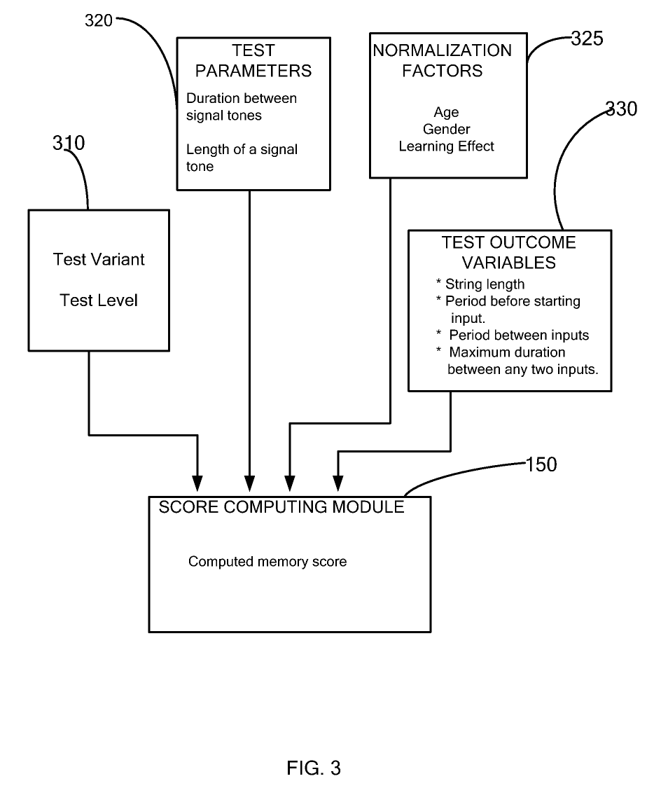

FIG. 3 shows an overview of the process for calculation of a composite score by the score-computing module.

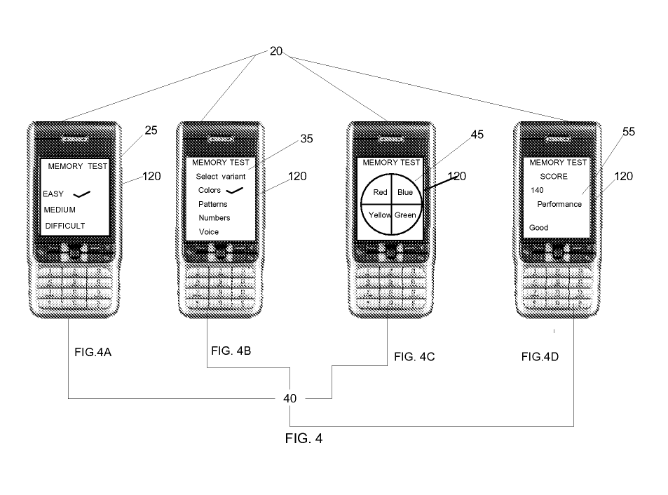

FIG. 4A-D illustrates the graphical user interface for an embodiment of a testing program residing on a mobile device.

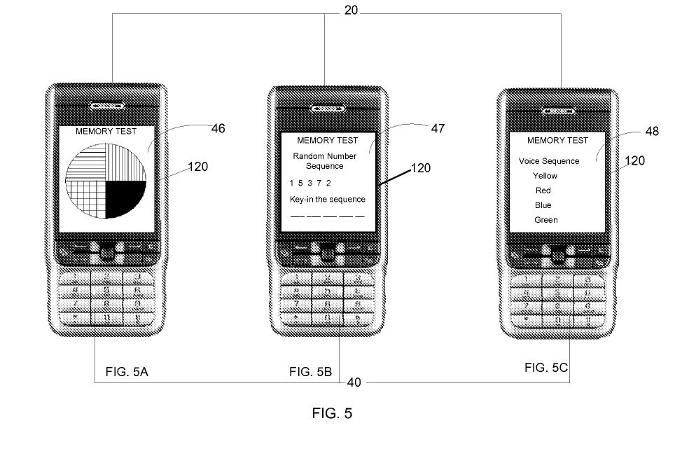

FIG. 5A-C show the graphical user interface of different test variants of an embodiment of the testing program residing on a mobile device.

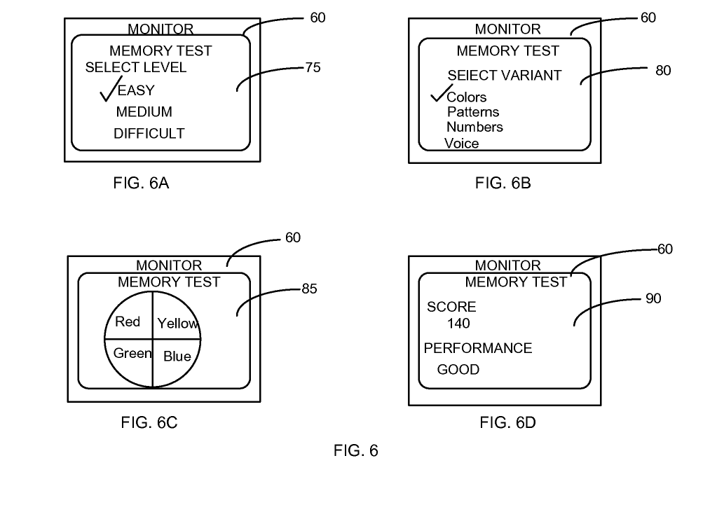

FIG. 6A-D illustrates yet another embodiment of the invention. The embodiment discloses the functioning of the testing program residing on a computer.

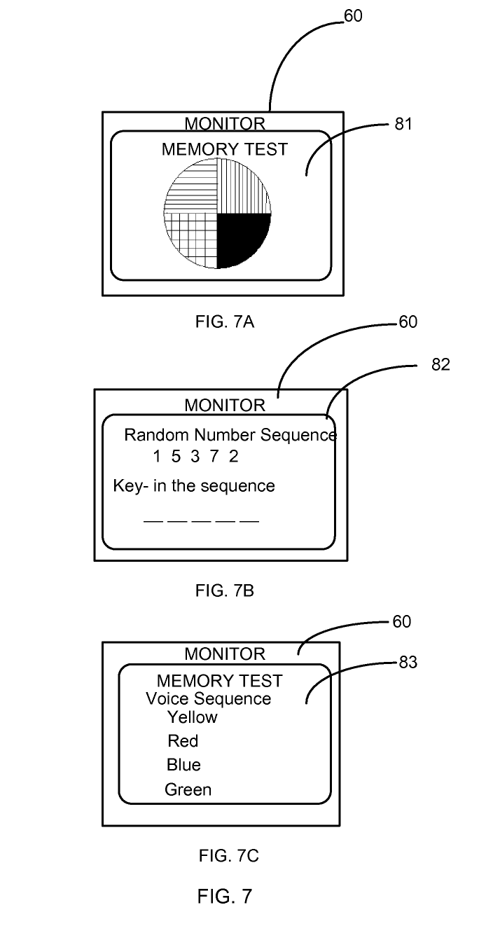

FIG. 7A-C illustrates yet another embodiment of the invention. The embodiment disclosed herein shows various combinations of the test variant.

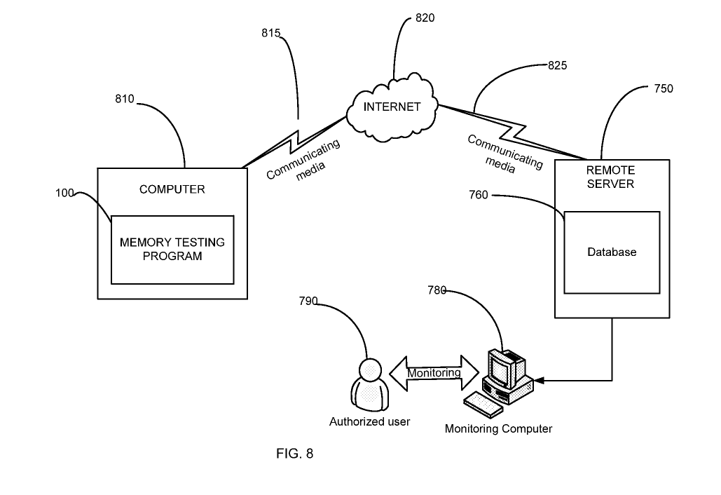

FIG. 8 shows an architectural view of an embodiment. The testing program resides on a mobile device and/or on a computer.

### DETAILED DESCRIPTION OF PREFERRED EMBODIMENTS

In the following description of various embodiments including the preferred embodiment, reference is made to the accompanying drawings, which show by way of illustration the embodiments in which the invention may be practiced. It is to be understood that other embodiments may be utilized and structural and functional modifications may be made without departing from the spirit or scope of the invention. Those skilled in the art will readily appreciate that the detailed description given herein with respect to these drawings is for explanatory purposes as the invention extends beyond these limited embodiments.

A variety of tests can be generated by varying the combinations of different types of stimuli, for example, visual stimuli, auditory stimuli, positional stimuli, vibratory stimuli, etc. Tests can also be generated by varying the level of difficulty. The memory score may be better determined by conducting not a single test, but a battery of multiple tests designed to test response to different stimuli. The battery of tests given to the examinee is also known as a test matrix.

There is a natural variation of memory even among normal persons because of age and gender. Therefore, the absolute scores generated by the testing device need to be adjusted by normalization factors for age and gender. Similarly, it has been observed that there is generally an initial improvement in absolute scores of most examinees during an initial learning period, followed by a subsequent leveling of the scores. This type of improvement in the scores is known as learning effect. The absolute scores generated by the testing device need to be also adjusted by normalization factors for learning effect.

The memory scores are affected by the combination of stimuli observed by the examinee. The tests can be based on different combinations of stimuli, for example, visual, auditory, positional, and vibratory stimuli. The absolute scores generated by the testing device need to be also adjusted for this factor.

FIG. 1 shows an overview of an embodiment of the invention as disclosed herein. The embodiment discloses a memory testing program 100 (hereinafter called testing program) residing on a client device (for example, a personal computer, a mobile device, etc.), generally used for testing and monitoring the memory of an examinee. Memory can be defined as a measure of the mental capability of a person for knowing, including aspects such as awareness, perception, reasoning, and memory. An examinee can be a healthy individual of any age group or a patient suffering from dementia or any other cognitive impairment condition. The testing program 100 includes a sequence generator module 110 for generating a random sequence of signals, a controlling module 160, and score computing module 150 for computing memory score (hereinafter called composite scores). The composite scores can be recorded in a memory 140 residing in the client device.

A test variant is a type of test, which is designed for a specific group of examinees. For example, a color selection variant is a test variant in which a sequence of colors is displayed to an examinee and is designed for all persons not having any visual impairment condition. Similarly, a pattern selection variant is a test variant designed for persons who are color-blind, and in this variant, a sequence of patterns is displayed to the examinee. A random number variant is also designed for color-blind persons, and in this variant, random numbers are displayed to the examinee. For persons whose visual impairment is substantial, the voice recognition variant may be more suitable. In the voice recognition variant, a speaker attached with the program plays out voice objects (e.g., the names of different objects) in a particular sequence. A test matrix is a battery of tests, different tests having different test levels and designed to measure different aspects of memory (such as but not limited to, visual memory, audio memory, and the like). The test level can be defined as the level of difficulty of a test. For example, the test level may be easy, medium or difficult. Test parameters are parameters, which influence the behavior of a test variant. Examples of test parameters are period between signal tones, length of a signal tone, the speed at which signals are shown to the examinee, etc. Test parameters may change automatically when the test matrix is changed.

In the embodiment of FIG. 1, the test variants and the test matrix can be selected using the controlling module 160. The controlling module 160 can have an automatic control mechanism 162 and a manual control mechanism 164. The automatic control mechanism 162 may change the test levels automatically based on the composite scores of the examinee. For example, if the examinee has opted for easy test level and the examinee has scored high scores in three consecutive tests, the automatic control mechanism 162 may change the test level from easy to medium. The examinee selects the test variant and test matrix using a control menu of the testing program 100.

In the testing program 100, the sequence generator 110 generates a sequence of signals. The sequence generator 110 includes a random number generator 112 and a signal sequence generator 114. The random number generator 112 generates a series of random numbers. The signal sequence generator 114 generates a random sequence of signals by associating signals with random numbers. There are various ways of generating random numbers, which are well known to persons skilled in the art. The signal sequence generator 114 generates random sequences of different types of signals for different test variants. For example, if color selection variant is selected, the signal sequence generator 114 generates signals that are expressed as various sequences of colors, such as red, blue, green, yellow, etc. If pattern selection variant is selected, signals are expressed as various patterns. If random number variant is selected, the series of random numbers is displayed directly on the graphical user interface 120. If voice recognition variant is selected, the signals are expressed as voice objects. Each signal can include a variety of components, such as but not limited to, a visual component, an auditory component, and/or a positional component. A visual component can be further composed of a color subcomponent, a pattern subcomponent and/or a light intensity subcomponent. An auditory component can be further composed of a frequency range subcomponent and a sound intensity subcomponent. A positional component can be shown by a position on the graphical user interface 120.

Depending on the test variant selected, the testing program 100 plays out different sequences of signals to the examinee. The examinee recalls the sequence of signals and attempts to input the same sequence using the graphical user interface 120 and a keyboard and/or a keypad with alphabetical and/or numerical keys, a set of soft keys, and/or a microphone, etc. Test outcome variables measure the actions and timings of the inputs entered by the examinee in the testing program. Examples of test outcome variables are total string length, period before starting input, period between inputs, error ratio, pre-error string length, etc. The total string length can be defined as the number of signals in a sequence of signals. The period before starting input can be defined as time taken by the examinee before his first input. The period between the inputs is the time taken by the examinee between inputting two consecutive signals. The pre-error string length can be defined as total number of correct signal inputs given before the examinee makes an error. The error ratio can be computed by dividing total number of errors by the total string length. The test outcome variables can be measured using a variety of measuring devices, for example a timer module, etc. which are well known in the art.

A score-computing module 150 computes a composite score based on a test variant, test parameters, and test outcome variables. The composite score may be calculated using data based on the values of the test paramerters, the test outcome variables, and the normalization factors for age, gender, and learning effect. The composite score may have a positive or negative correlation with different test parameters and test outcome variables. For example, if there is increase in the average period between the inputs of the examinee, this results in a decrease in the composite score.

The composite score can be recorded in a memory 140 residing in the client device (for example, a personal computer, a mobile device, etc.). The composite score can be transmitted to a database residing on a remote server. The testing program 100 may have a time-controlled data-uploading program, which uploads the data automatically to the remote server after a predefined time-period. The composite score can be displayed to the examinee on a graphical user interface 120 of the client device.

In an embodiment, after successful completion of a test of a specific string length (number of signals in the sequence) the testing program, may increase the string length in the next test. In other embodiments, the string length may be increased only after completion of a specified number of tests having the same string length.

The testing program 100 may double up as a mental stimulating fun game to enhance memory of the examinee and as a memory-improving program for an individual suffering from dementia and other cognitive diseases.

FIG. 2 shows a flow diagram illustrating the process flow for working of a memory testing program 100 residing on a client device.

In step 200, an examinee selects a test variant and a test level using a controlling module 160.

In step 205, a random number generator present in a sequence generator generates a series of random numbers.

In step 210, a signal sequence generator generates a sequence of signals by associating signals with random numbers.

In step 215, the sequence of signals is displayed to an examinee.

In step 220, the examinee recalls the signals and attempts to input the same sequence using a graphical user interface 120 of the client device.

In step 225, a score-computing module computes the composite score of the examinee based on a test variant, a test level, test outcome variables, and test parameters.

In step 230, a memory 140 records test data including test outcome variables, test parameters, composite scores, etc.

In step 235, the composite scores are displayed to the examinee using the graphical user interface 120 of the client device.

FIG. 3 shows an overview of the process for calculation of a composite score by the score-computing module 150. The score computing module 150 computes the memory score based on the test variant 310, the test matrix 315, the test parameters 320, and the test outcome variables 330. The test variant 310 can be selection of colors, patterns, random numbers, and/or voice recognition etc. The test level can be, for example, easy, medium, difficult, etc. The test parameters 320 can be, for example, interval between signal tones, length of signal tone, etc. The composite score needs to be adjusted for normalization factors 325 for age and gender of the examinee and the learning effect. The test outcome variables 330 can be, for example, string length, period before starting input, periods between inputs, error ratio, pre-error string length.

The composite score may have a positive or negative correlation with different test parameters and test outcome variables. If with the increase in one variable and/or parameter there is decrease in the score it can be termed as negative correlation. Similarly if with the increase in one variable and/or parameter there is increase in the score, it will be termed as positive correlation.

If the string length in any test increases, then irrespective of other test parameters like duration between the signal tones and the length of signal tones, the score increases. This can be termed as a positive correlation. If any of the duration before starting input, average duration between inputs and maximum duration between any two inputs decreases, the score increases. This can be termed as negative correlation.

In addition, the composite memory score can be affected based on a pre-error string length as well as an error ratio. The illustration is by way of an example and should not be limited to the scope of the example.

For example:—The sequence generator generates a sequence of signals with string length 15. The examinee recalls the sequence and inputs the same sequence. The testing program will take all the 15 inputs without restricting the examinee if he has entered a wrong signal as his input. In a test, the sequence generator has generated a sequence of signals with string length 15. The examinee after recalling the sequence entered 12 signals correctly followed by 1 errored signal and again 2 signals correctly, as his input. Thus, the pre-error string length in this example is 12, and the error ratio is computed by dividing total number of errors by the total string length. The composite score can be calculated based on the values obtained as the pre-error string length and the error ratio.

FIG. 4A-D illustrates the graphical user interface 120 for an embodiment of a testing program residing on a mobile device 20. The embodiment discloses the functioning of the testing program 100 residing on the mobile device 20. The illustrations are by way of example and are not limited to the scope of the example.

FIG. 4A shows a test level selection menu 25 of the testing program 100 residing on a mobile device 20. The test level selection menu 25 is used by an examinee for selecting a test level using the test level selection menu 25. The test level may be easy, medium, difficult, etc. Let us assume the examinee selects “EASY” as test level using test level selection menu 25 of the testing program 100 residing on the mobile device 20.

FIG. 4B shows a test variant selection menu 35 for selecting a variant of the testing program 100 residing on the mobile device 20. The test level selection menu 35 is used by an examinee for selecting a test variant using the test variant selection menu 35 displays to the examinee using the test variant selection menu 35. The test variant may be a color selection variant, a pattern selection variant, a random number variant, a voice object variant, etc. Let us assume the examinee selects “COLOR VARIANT” 45 using the test variant selection menu 35 of the testing program 100 residing on the mobile device 20.

In FIG. 4C, the testing program 100 based on the selected test level “EASY” and the selected test variant “COLOR VARIANT”, generates a sequence of colors using the sequence generator 110 and displays the sequence on the graphical user interface 120. The examinee recalls the same sequence from memory and keys in his inputs using the soft keys positioned below the graphical user interface 120. Each soft key can be assigned to a predefined signal.

In FIG. 4D, the score-generating module 150 generates the memory score 55, based on the test level, the test variant, and the test outcome variables. The memory score 55 along with the performance of the examinee can be displayed on the graphical user interface 120 of the mobile device 20 on which the testing program resides. The memory score can be transferred to a remote server, which can be accessed by an authorized person for monitoring the cognitive performance of the examinee.

FIG. 5A-C show the graphical user interface 120 of different test variants of an embodiment of the testing program 100 residing on a mobile device 20. The illustrations disclosed herein show various test variants. The illustrations shown are by way of example only and should not be considered to be limiting the scope of the invention.

FIG. 5A shows a pattern test variant 46. The patterns can be of any tupe, such as parallel lines pattern, concentric circle pattern, square patterns, intersecting lines pattern, and the like. If the examinee selects the pattern selection variant 46, the sequence generator 110 can generate a sequence of patterns and display the sequence using the graphical user interface 120 of the mobile device 20 on which the testing program 100 resides.

FIG. 5B shows a random number test variant 47. If the examinee selects the random number sequence variant 47, the sequence generator 110 can generate a sequence of random numbers and display the sequence using the graphical user interface 120 of the mobile device 20 on which the testing program 100 resides.

FIG. 5C shows a voice object test variant 48. If the examinee selects the voice object variant 48 of varying tone ranges, the sequence generator 110 generates a sequence of voice objects using a speaker (not shown) embedded in the mobile device 20. An examinee memorizes the sequence of voice objects and recites the sequence into the mobile device 20 using a microphone (not shown) embedded in the mobile device 20. The speech recognition module (not shown) may be used to verify that the examinee memorized the correct sequence.

It is known that people may lose their sensitivity to audio signals of certain frequencies as they age. In an embodiment, the desired frequency range may be automatically selected depending on the age of the examinee retrieved from the examinee personal data submitted by the examinee or his/her sponsor at the time of subscription to the services described in this application.

FIG. 6A-D shows a few illustrative screens of yet another embodiment of the testing program as implemented on a personal computer (not shown) having a CPU, a display monitor 60, a memory, and input devices. Examples of the monitor 60 can be a touch screen, LCD display, etc. In FIG. 6A, the testing program 100 displays a test level selection menu 75 for selecting a test level by the examinee. The test level can be easy, medium, difficult, etc. For example, the examinee may select “EASY” as test level using the test level selection menu 75 on the display monitor 60 of the computer on which the testing program 100 resides.

In FIG. 6B, the testing program 100 displays a test variant selection menu 80 for selecting a variant of the test by the examinee. The test variant may be a color selection variant, a pattern selection variant, a random number generation variant, a voice recognition variant, etc. For example, the examinee may select the “COLOR SELECTION VARIANT” using the test variant selection menu 80 on the display monitor 60 of the computer on which the testing program 100 resides.

FIG. 6C shows an exemplary illustration of a test variant 85 of the testing program 100, The test variant 85 shows by way of illustration only a sequence of colors to the examinee on the display monitor 60. The examinee recalls the same sequence and key-in his inputs using the keyboard of the computer on which the testing program 100 resides.

FIG. 6D shows an exemplary illustration of a display of a composite score 90 generated by the score-generating module 150 shown in FIG. 1. The composite score 90 may be displayed on the display monitor 60 of the computer on which the testing program 100 resides. In another embodiment of the testing program 100, the composite score 90 may be transferred to a remote server (not shown) for enabling remote monitoring of the examinee scores by authorized persons.

FIG. 7A-C illustrate by way of example different test variants of the testing program 100. The illustrations are shown by way of example and should not be considered to be limiting the scope of the invention.

FIG. 7 A shows a pattern selection variant 81. If the examinee selects the pattern selection variant 81, the sequence generator 110 can generate a sequence of patterns and display the sequence using the display monitor 60 of the computer on which the testing program 100 resides.

FIG. 7B shows a random number selection variant 82. If the examinee selects the random number sequence variant 82, the sequence generator 110 can generate a sequence of random numbers and display the sequence using the display monitor 60 of the computer on which the testing program 100 resides.

FIG. 7C shows voice recognition variant 83. If the examinee selects the voice recognition variant 83, the sequence generator generates signals that can be expressed as sequences of voice objects.

FIG. 8 shows an architectural view of an embodiment of a memory measurement system. In this embodiment, the system comprises the testing program 100 residing on a client device 810 (for example, a mobile device, a computer, etc.). The recorded test parameters, test outcome variables, and the composite score can be transmitted through an internet network 820. The client device 810 can be connected to the internet network 820 using a communicating medium 815, such as but not limited to, a modem, a wired network and/or a wireless network. The recorded test parameters and test outcome variables can be transmitted to a database 760 residing over the remote server 750 through the internet 820. The remote server 750 may include a database 760. The database 760 on the remote server 750 can be used for storing the examinee personal data, test matrices, test parameters, test outcome variables, and composite memory score for recording and for computing composite score time series, composite score trend charts for each examinee.

The remote server 750 can be connected to a monitoring computer 780, such as a laptop computer, a desktop computer, a PDA, etc. of an authorized user 790 for monitoring the progress of memory of an examinee. The authorized user 790 can be children or family of the examinee, a medical practitioner, a researcher, government authorities and the like. The remote server 750 can be accessed using a public computer network (such as internet, etc.) or a private computer network (such as intranet, etc). In an embodiment, a medical practitioner may remotely change the test matrix on an internet capable device (e.g. a personal computer, etc.). This changes the test matrix stored in the examinee's records in the central database storing examinee personal data, test outcome variables, composite score data, and test matrices of all the examinees. When the testing device establishes a connection with the central database, the changes test matrix gets downloaded automatically to the testing program. During the subscription process, the examinee or the authorized user may enter examinee personal data e.g. age, gender, physiological limitations, etc. The examinee personal data may also be used to compute the normalization factor of age, gender, etc.

Having fully described the preferred embodiment, other equivalent or alternative methods of testing memory of an examinee according to the present invention will be apparent to those skilled in the art. The invention has been described above by way of illustration, and the specific embodiment disclosed is not intended to limit the invention to the particular forms disclosed. For example, the embodiments described in the foregoing were directed to providing you clear ideas about the preferred modes, including the best mode, of making and using the present invention; however, in alternate embodiments, those skilled in the art may implement the invention using various other means without deviating from the central idea of the invention. The invention therefore covers all modifications, equivalents, and alternatives falling within the spirit and scope of the following claims.

I claim:

1. A method for conducting memory measurement tests based on memorizing random sequences of signals and for recording and displaying test results, the method comprising the steps of:
selecting a test variant and a test matrix on a graphical user interface of a client device;
measuring test outcome variables based on timings and action of an examinee;
computing composite score data based on at least one of test matrix, test outcome variables, and normalization factors for learning effect, gender, and age of the examinee;
storing the test outcome variables and the composite score data for the examinee in a memory medium;
displaying the composite score data; and
transmitting automatically, via a communication interface on the client device, the test outcome variables, and the composite score data of the examinee from the client device to a database residing on a remote web server, the database storing at least one of examinee personal data, the test outcome variables, the composite score data, and the test matrices of all the examinees.

2. The method of claim 1, further comprising the step of displaying the the composite score data stored in the database to authorized users accessing the database through a web browser residing on an internet capable device.

3. The method of claim 2, wherein the authorized users operating the internet capable device can remotely change the test matrix, the changed test matrix being transmitted to the database residing on the remote web server and the changed test matrix being downloaded to the client device

4. The method of claim 1, wherein a control module can change automatically the test variant based on physiological limitations of the examinee and change automatically the test matrix based on the composite score data of the examinee.

5. The method of claim 1, further comprising generating a random sequence of signals by a sequence generator module, wherein each signal comprises at least one of a visual component, an auditory component, and a positional component, and wherein the visual component includes at least one of a color subcomponent, a pattern subcomponent, and a light intensity subcomponent.

6. A computer-readable medium residing on a client device, allowing an examinee to select a test variant and a test matrix, and including instructions for conducting memory measurement tests and for recording and displaying results, the instructions comprising:
generating a random sequence of signals by a sequence generator module of a testing program residing on a client device;
measuring test outcome variables resulting from an examinee memorizing and inputting the memorized sequence of signals into the client device;
computing composite score data based on at least one of test variant, test matrix, test outcome variables, and normalization factors for learning effect, gender, and age of the examinee;
storing the test outcome variables and the composite score data for the examinee in a memory medium; and
displaying the composite score data.

7. The computer-readable medium of claim 6, including additional instructions for transmitting and displaying composite memory test scores, the instructions comprising:
transmitting automatically, via a communication interface on the client device, the test outcome variables and the composite score data for the examinee from the client device to a database residing on a remote web server, the database storing at least one of examinee personal data, the test outcome variables, the composite score data, and the test matrices of all the examinees;
displaying the test outcome variables and the composite score data stored in the database to authorized users accessing the database through a web browser residing on an internet capable device.

8. The computer-readable medium of claim 6, wherein the random sequence of signals comprises at least one of a visual component, an auditory component, a positional component, and a tactile component, and wherein the visual component includes at least one of a color subcomponent, a pattern subcomponent, and a light intensity subcomponent.

9. The computer-readable medium of claim 6, wherein the random sequence of signals is an alphanumeric string.

10. The computer-readable medium of claim 6, wherein the random sequence of signals is a sequence of voice objects and wherein the computer-readable medium further comprises:
a speech synthesizer module for generating voice objects of varying tone ranges; and
a speech recognition module for deciphering the spoken voice objects.

11. The computer-readable medium of claim 6, wherein the client device on which the computer-readable medium resides is a personal computer.

12. The computer-readable medium of claim 6, wherein the client device on which the computer-readable medium resides is a mobile device.

13. The computer-readable medium of claim 12, wherein the mobile device is a mobile phone or a PDA.

14. The computer-readable medium of claim 6, further comprising a control module that changes automatically the test variant based on physiological limitations of the examinee and changes automatically the test matrix based on the composite score data of the examinee.

15. The computer-readable medium of claim 6, wherein the test outcome variables comprise at least one of total string length, period before starting input, periods between inputs, error ratio, and pre-error string length.

16. A system for conducting memory measurement tests and for recording, transmitting, and displaying memory test data and memory test trends, the system comprising:
the computer-readable medium of claim 7, residing on a client device;
a database residing on a remote server for receiving the composite score data from the client device, the database storing at least one of examinee personal data, the test outcome variables, the composite score data, and the test matrices of all the examinees; and
an internet capable device having a web browser connectable to said database on the remote server for authorized persons to remotely view the composite score data of the examinee and to remotely change the test matrix of the examinee.

17. The system of claim 16, wherein the computer-readable medium comprises a control module for changing automatically the test variant based on physiological limitations of the examinee and changing automatically the test matrix based on the composite score data of the examinee.

18. The system of claim 16, wherein the random sequence of signals generated by the sequence generator module comprises at least one of a visual component, an auditory signal tone component, an auditory voice object component, and a positional component, and wherein the visual component includes at least one of a color subcomponent, a pattern subcomponent, and a light intensity subcomponent.

19. The system of claim 16, wherein the client device on which the computer-readable medium resides is a personal computer.

20. The system of claim 16, wherein the client device on which the computer-readable medium resides is a mobile device.
